(19) United States
(12) Patent Application Publication
(10) Pub. No.: US 2026/0363283 A1
(43) Pub. Date: Nov. 19, 2026

(54) METHOD FOR PREPARING DRIED ROLLED LAVER BY USING COMPOSITE DRYING MODE

(71) Applicant: CJ CHEILJEDANG CORPORATION, Seoul (KR)

(72) Inventors: Seung Bae JI, Seoul (KR); Dae In LEE, Seoul (KR); Beomseok KANG, Seoul (KR); Jaehoon LEE, Seoul (KR); In Seop SHIN, Seoul (KR); Taehan KIM, Seoul (KR); Mun Hui JO, Seoul (KR)

(73) Assignee: CJ CHEILJEDANG CORPORATION, Seoul (KR)

(21) Appl. No.: 19/126,167

(22) PCT Filed: Sep. 7, 2023
(86) PCT No.: PCT/KR2023/013413

§ 371 Date: Apr. 30, 2025

(30) Foreign Application Priority Data
Oct. 31, 2022 (KR) 10-2022-0143155

(51) Int. Cl. A23L 17/60; A23B 2/94; A23L 5/20; A23P 30/00

(52) U.S. Cl. CPC A23L 17/60; A23B 2/945; A23L 5/20; A23P 30/00

(57) ABSTRACT

The present disclosure relates to a method for producing rolled dried laver.

### TECHNICAL FIELD

The present disclosure relates to the method for producing rolled dried laver.

### BACKGROUND ART

Laver, perennial red algae belonging to the Pyropia family, are distributed worldwide with approximately 140 species. In Korea, there are over 20 native species of laver, and among the domestic cultivated varieties, Pyropia yezoensis accounts for the largest proportion, making up 70% of the cultivated varieties. Laver grows attached to surfaces in the ocean like moss or is primarily cultivated along the southwestern coast of South Korea, which is harvested and processed to be widely used as food.

The conventional method for producing laver involves untangling raw laver harvested from sea farms in large storage tanks, removing foreign substances, cutting the raw laver into specific sizes and maturing it in a washing and grinding machine, then placing the matured laver in a frame and spreading it across the laver sheet to create a rectangular shape, and drying the laver either with a hot air dryer or through natural drying. For example, Korean Patent Application No. 10-2015-0042909 relates to a method for producing laver using microorganisms, comprising washing, cutting, fermentation, forming, and drying.

However, conventional methods for producing dried laver have had the following problems.

First, since raw laver is formed in a rectangular frame, the size, shape, and thickness of dried laver is uniform, making it impossible to produce dried laver in various forms. Second, since dried laver is produced as individual sheets through frame forming, a significant amount of labor is required for packaging, logistics, storage, and input during laver production, leading to high labor costs. Third, during the process of placing raw laver into a frame for laver formation, the raw laver particles may be unevenly distributed, making it difficult to produce dried laver with a uniform thickness; additionally, holes may form on the surface of the dried laver, or the laver may tear easily when making kimbap, leading to quality issues. Fourth, when a sponge is used to press the surface of the laver formed in a frame for dewatering before it is placed into a dryer, residual water in the sponge may become a breeding ground for microorganisms. This may lead to transfer of microorganisms to the laver and increase the microbial presence in the final dried laver product. Fifth, since raw laver mixed with a large amount of water is directly formed in a frame, dewatered, and dried, adding other ingredients or food additives during the production of dried laver is difficult. As a result, production is limited to only dried laver with uniform composition. Sixth, when indirectly drying raw laver under hot air at approximately 40 °C with a humidity of 50% to 60%, the drying process takes more than two hours, potentially leading to increased costs and posing limitations on productivity improvement.

In light of this background, in order to solve the aforementioned issues, the present inventors have developed a method for producing laver with a simplified process and reduced production time, which enables the production of high-quality rolled dried laver that preserves the unique taste and aroma of laver, has uniform density and thickness, exhibits high strength, minimizes microbial contamination, and reduces laver shrinkage.

### DISCLOSURE

### Technical Problem

The present disclosure aims to provide a method for producing rolled dried laver and rolled dried laver produced by the method.

### Technical Solution

One object of the present disclosure is to provide a method for producing rolled dried laver, comprising: a sheeting step (S60) of forming a sheet by loading raw laver onto a mesh belt; a dewatering step (S80) of dewatering the raw laver sheet formed in the sheeting step (S60); a pre-drying step (S90) of primarily drying the dewatered raw laver sheet from the dewatering step; and a drum-drying step (S100) of secondarily drying the primarily dried raw laver sheet using a drum dryer after the pre-drying step (S90).

Another object of the present disclosure is to provide rolled dried laver produced by the method for producing rolled dried laver.

### Advantageous Effects

The method for producing rolled dried laver of the present disclosure allows for variations in thickness and weight by adjusting process conditions unlike conventional dried laver with uniform specifications. Additionally, the method for producing rolled dried laver of the present disclosure provides roll laver with uniform density and thickness by preventing shrinkage during the drying process. Additionally, various types of raw material powder or food additives may be added with high penetration efficiency, enabling the provision of dried laver with improved flavor and umami. Moreover, the method for producing rolled dried laver of the present disclosure allows laver to be produced in a roll form, enabling the cutting of laver into various shapes rather than being limited to conventional rectangular laver products.

Additionally, since the method for producing rolled dried laver of the present disclosure yields laver in a roll form, connecting a laver processing step into downstream of the dried laver manufacturing process enables the continuous automated production of processed laver. This allows for reduced labor costs, shorter production time, and increased productivity. Furthermore, the method for producing rolled dried laver of the present disclosure minimizes microbial contamination, enabling the production of dried laver with improved quality.

Next, the method for producing rolled dried laver of the present disclosure employs a combined drying method of pre-drying and drum-drying while incorporating a direct drying method, thereby significantly enhancing drying efficiency. As a result, it ultimately improves both the production efficiency and quality of the dried laver. Furthermore, by utilizing a two-step drying process of pre-drying and drum-drying, the method for producing rolled dried laver of the present disclosure enhances the strength of the dried laver, effectively resolving the issue of tearing during kimbap production. Additionally, the hot air drying effect achieved during drying eliminates the need for a separate hot air drying process, contributing to cost reduction.

### BRIEF DESCRIPTION OF THE DRAWINGS

FIGS. 1 and 2 are diagrams illustrating the operational steps according to each embodiment of the present disclosure.

FIG. 3 is a diagram illustrating the contour plot of the area ratio of a laver sheet according to the adjustment of temperature and humidity in the pre-drying step.

FIG. 4 is a diagram illustrating a forming process of roll laver according to an embodiment of the present disclosure.

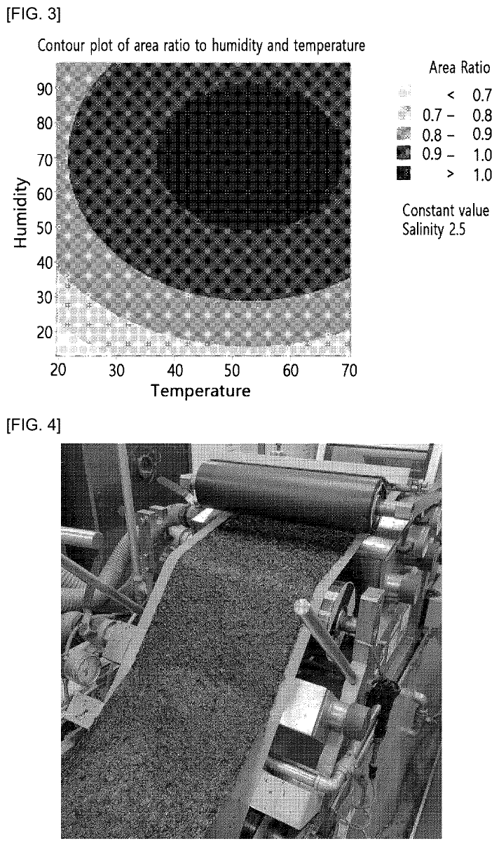

FIG. 5 is a diagram illustrating a product photo of roll laver according to an embodiment of the present disclosure.

### DETAILED DESCRIPTION OF PREFERRED EMBODIMENTS

The present disclosure will be described in detail as follows. Meanwhile, each description and embodiment described herein may be applied to other descriptions and embodiments, respectively. That is, all combinations of various elements disclosed in this invention fall within the scope of the present disclosure. Further, the scope of the present invention is not limited by the specific description described below. Additionally, throughout the entirety of the specification, multiple papers and patent documents are referenced, and their citations are indicated. The disclosed content of the cited papers and patent documents is incorporated herein by reference in its entirety, thereby clarifying the level of the technical field to which the present disclosure pertains and providing a more precise explanation of the present disclosure.

One aspect of the present disclosure provides a method for producing rolled dried laver, comprising: a sheeting step (S60) of forming a sheet by loading raw laver onto a mesh belt; a dewatering step (S80) of dewatering the raw laver sheet formed in the sheeting step (S60); a pre-drying step (S90) of primarily drying the dewatered raw laver sheet from the dewatering step; and a drum-drying step (S100) of secondarily drying the primarily dried raw laver sheet using a drum dryer after the pre-drying step (S90).

The method for producing rolled dried laver of the present disclosure may further comprise a pre-treatment step (P), which comprises removing foreign substances from the harvested raw laver and forming particles and density appropriate for a sheet form before the sheeting step.

Further, the method for producing rolled dried laver of the present disclosure may further comprise one or more of a maturing step (S40), and a dilution step (S50), before the sheeting step (S60).

Further, the method for producing rolled dried laver of the present disclosure may further comprise an additive adding step (S70) after the sheeting step (S60) and before the dewatering step (S80).

The method for producing the rolled dried laver of the present disclosure may be performed continuously from the sheeting step (S60) to the drum-drying step (S100).

First, as used herein, the term “laver” refers to seaweed belonging to the family Bangiaceae, and laver is a high-protein food with a very high protein content relative to common seaweed. Laver is known to be rich in taurine, which promotes alcohol breakdown. Further, laver is rich in various nutrients, such as vitamins, carbohydrates, fiber, calcium, iron, and phosphorus, and thus, laver has a variety of effects such as preventing aging, preventing osteoporosis, and enhancing immunity.

As used herein, the term “dried laver” refers to a dried product of harvested raw laver, and can be understood as equivalent to dry laver. Conventional dried laver is typically in the specification of a dry, flat, rectangular sheet.

As used herein, the term “roll laver” refers to laver in a longitudinally rolled, cylindrical form of laver and can be understood as equivalent to scroll laver, scroll-type laver, or roll-type laver.

The present disclosure provides a method for preparing dried laver in a form of roll laver such that the laver can be formed into various appearances without being limited to the conventional standardized rectangular shape of laver and processed with high efficiency. In particular, the method for producing rolled dried laver of the present disclosure comprises a combination of the sheeting step, pre-drying step, and drum-drying step as mentioned above, therefore, the technical feature of the present disclosure lies in free adjustment of the thickness and provision of high-strength and uniform roll laver.

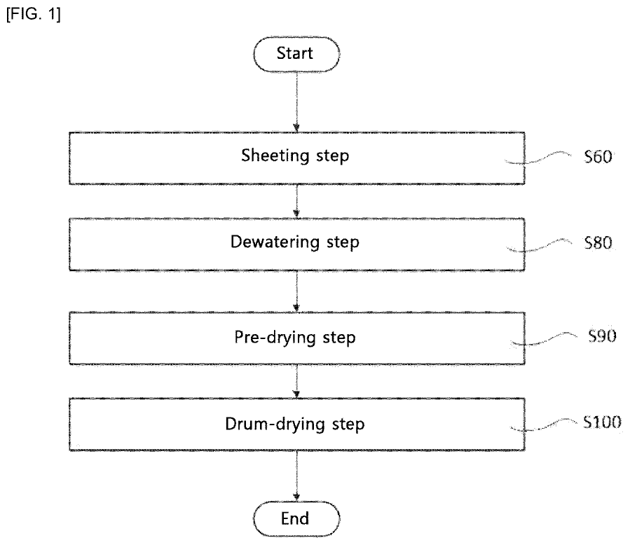

FIGS. 1 and 2 are diagrams illustrating the operational steps according to an embodiment of the present disclosure.

Hereinafter, each step of a preferred embodiment of the present disclosure will be described in detail based on the accompanying drawings.

The pre-treatment step (P) refers to the process of removing foreign substances contained in the harvested raw laver and adjusting the particles and density appropriate for the formation of laver in a long sheet. The pre-treatment step (P) may be a conventional pre-treatment step applied in a laver manufacturing process. For example, the pre-treatment step may comprise a sorting step (S10), a dewatering step (S20), or a cutting step (S30).

The sorting step (S10) refers to the process of removing foreign substances in the harvested raw laver. The harvested raw laver is typically stored in a storage tank with water, and foreign substances in such a state of raw laver are removed using a sorter. In particular, the sorter to be used may be a sorter for foreign substances or a centrifuge that are commonly used for removing foreign substances in a raw laver manufacturing process, but is not particularly limited thereto.

The dewatering step (S20) refers to the step of decreasing moisture content in the raw laver. The dewatering is not limited to a specific method as long as it is a conventional dewatering method used in a laver manufacturing process. For example, the dewatering may be performed by a press dehydrator, centrifugal dehydrator, screw dehydrator, etc., but is not limited thereto.

The cutting step (S30) refers to the process of cutting the raw laver dewatered in the dewatering step (S20) into small pieces to ensure uniform thickness and density, and easy forming into long raw laver sheets. The cutting size of raw laver may be specifically 2 mm to 9 mm, more specifically 3 mm to 7 mm, but is not limited thereto, and may vary according to the target use and form of laver. For example, when producing laver for kimbap, laver may be cut into a size of 3 mm, and when producing laver for seasoning, it may be cut into a size of 7 mm. However, the cutting size is not limited thereto.

Next, the maturing step (S40) refers to the process of mixing the pre-treated raw laver from the pre-treatment step (P) with fresh water, adjusting the salinity, and allowing the laver to mature. This step ensures that the cut raw laver adheres well to the mesh belt and forms a sheet in the sheeting step (S60) described below.

In one embodiment of the present disclosure, the maturing step (S40) may involve transferring the cut raw laver to a maturing tank and mixing it with fresh water, adjusting the salinity using a saline solution, and stirring.

Specifically, in the maturing step (S40), the mixing ratio of raw laver and fresh water may be 1:5 to 1:10, and more specifically 1:8. If the mixing ratio of raw laver and fresh water is lower than 1:5, the mixing becomes difficult. On the other hand, if the mixing ratio exceeds 1:10, the required amount of salt or other additives to adjust salinity increases, leading to higher costs.

Specifically, in the maturing step (S40), the salinity may be adjusted within a range of 0.1% to 5%, more specifically 0.5% to 3.5%, and preferably 1% to 3%. In particular, adjusting the salinity within the above range can prevent shrinkage and deformation of the raw laver during the drying step, thereby improving the quality of the final laver product. Additionally, maintaining the freshness of the raw laver enhances the gloss and taste of the final product and facilitates its detachment from the conveyor belt.

Specifically, the maturing step (S40) may be performed for 0.5 to 4 hours, more specifically, 0.8 to 3 hours, and most specifically, 1 to 2 hours.

During the maturing step (S40), the loss of amino acids from the leaves of the cut raw laver due to osmotic pressure is minimized, allowing only moisture to escape. The dehydrated leaves undergo structural changes that increase adhesion between the raw laver particles when subsequently loaded onto the mesh belt, thereby facilitating the formation of raw laver sheet.

The dilution step (S50) refers to the process of further mixing water into the matured raw laver from the maturing step (S40), thereby ensuring better dispersion of the raw laver when subsequently loaded onto the mesh belt. In one embodiment of the present disclosure, the dilution step (S50) may involve passing the matured raw laver from the maturing step (S40) through a line mixer and further diluting it with saline water at a salinity of 0.5% to 3.5%.

Specifically, in the dilution step (S50), the ratio of matured raw laver and saline water may range from 1:0.5 to 1:2. In particular, water may be injected into the line mixer to adjust the salinity of the saline water, enabling the control of the dilution concentration as required.

The sheeting step (S60) refers to the process of loading the raw laver on the mesh belt and forming it into a sheet. Specifically, the sheeting step may utilize a mesh belt with a gradually height increasing incline. Further, the sheeting step may specifically include vacuum dewatering.

More specifically, the sheeting step (S60) may involve performing vacuum dewatering by loading the raw laver on a mesh belt with a gradually height increasing incline and passing it through a headbox in which the water level is maintained constant. In particular, the water level in the headbox is maintained constant, while the mesh belt loaded with raw laver has a gradually height increasing incline, causing its surface to rise above the water level. As a result, water drains out, and the raw laver settles uniformly on the mesh belt, forming a sheet. Additionally, as water is slowly removed through vacuum dewatering, the sheet can be formed with a more uniform thickness and density. In the production method of the present disclosure, by including such a sheeting step, even large raw laver particles can be uniformly formed into a sheet, enabling the sheet formation with uniform thickness and density.

Specifically, the raw laver used in the sheeting step may have a salinity of 1% to 3%, and more specifically 1% to 2.5%, 1.5% to 2.7%, or 2% to 3%.

Specifically, the mesh belt may be inclined at an angle of 10° to 30°, and more specifically, 10° to 20°, 20° to 30°, 15° to 25°, 10° to 15°, 15° to 20°, 20° to 25°, or 25° to 30°. Specifically, the specification of the mesh belt (63) may range from 40 mesh to 200 mesh.

Specifically, the vacuum may be a low vacuum of 100 mbar to 150 mbar, more specifically, 100 mbar to 130 mbar, 110 mbar to 140 mbar, 120 mbar to 150 mbar, 120 mbar to 140 mbar, 115 mbar to 130 mbar, or 125 mbar to 145 mbar. Through the vacuum dewatering, the moisture of the raw laver is gradually and efficiently removed as it settles on the mesh belt, enabling more uniform sheet formation.

Specifically, the sheeting step (S60) allows adjustment of the thickness of the raw laver sheet to be formed by controlling three factors: the concentration of the raw laver, the feeding speed, and the movement speed of the mesh belt. In particular, the feeding speed refers to the flow rate at which the solution containing the raw laver is introduced into the headbox. Specifically, the thickness of the raw laver sheet to be formed may be increased by increasing the raw laver concentration and reducing the speed of the mesh belt. In particular, the feeding speed may be adjusted to maintain the water level of the headbox and a continuous process. Further, the thickness of the raw laver sheet to be formed may be decreased by decreasing the raw laver concentration and increasing the speed of the mesh belt. In particular, the feeding speed may be adjusted to maintain the water level of the headbox and a continuous process.

In one embodiment of the present disclosure, the water containing salt collected beneath the mesh belt may be recovered, filtered to remove raw laver residues, and reused in the maturing step (S50).

The additive adding step (S70) refers to the process of adding raw material powder or food additives to the raw laver sheet formed from the sheeting step (S60) to improve taste and flavor. In one embodiment of method for producing the rolled dried laver of the present disclosure, the additive adding step (S70) may optionally be further included, if necessary.

Specifically, the raw material powder may be seafood, meat, or vegetable powder or the like.

Specifically, the food additives are not limited as long as it is an additive that may be used in the production of laver. For example, the food additives may comprise vitamin A, C, D, E, B1, B2, B6, or B12, niacin, biotin, folate, pantothenic acid, etc. Additionally, the food additives may include minerals such as zinc (Zn), iron (Fe), calcium (Ca), magnesium (Mg), manganese (Mn), copper (Cu), and chromium (Cr); and amino acids such as lysine, tryptophan, cysteine, and valine. Furthermore, the food additives may include preservatives (such as sodium dehydroacetate, sorbic acid, potassium sorbate, and sodium propionate), sterilizers (such as calcium hypochlorite and sodium hypochlorite), dibutylhydroxytoluene, colorants (such as Food Green No. 3 and β-carotene), color-developing agent (such as sodium nitrite and sodium nitrate), bleaching agents (such as sodium sulfite), flavor enhancers (such as L-monosodium glutamate), sweeteners (such as sodium saccharin, aspartame, and acesulfame potassium), flavoring agents (such as vanillin and lactones), leavening agents (such as potassium alum and DL-potassium hydrogen tartrate), fortifying agents, emulsifiers, thickeners (paste), coating agents, gum bases, anti-foaming agents, solvents, and improvers. The raw material powder or food additives may be selected depending on the target laver type and be used in appropriate amount.

In the production method of the present disclosure, additives added on the raw laver evenly penetrate into it during the subsequent dewatering step (S80) and pre-drying step (S90). As a result, the method for producing rolled dried laver of the present disclosure enhances the penetration efficiency of additives, enabling the production of dried laver with a variety of flavors characterized by enhanced umami and a rich taste.

The dewatering step (S80) refers to the process of removing moisture contained in the raw laver sheet formed in the sheeting step (S60).

Specifically, the dewatering may include vacuum dewatering. In the method for producing the rolled dried laver of the present disclosure, vacuum dewatering may be performed instead of the conventional direct-contact dewatering using a sponge, thereby reducing the risk of microbial contamination in the dried laver. Additionally, when raw material powder or food additives are applied to the surface of the raw laver, they can partially dissolve in the residual moisture and be replaced by the water removed during the dewatering step (S80), allowing them to easily penetrate into the raw laver sheet. More specifically, the vacuum dewatering may utilize a high vacuum box.

Specifically, the vacuum dewatering may be performed at a vacuum level of 100 mbar to 200 mbar, more specifically 120 mbar to 170 mbar. In particular, by adjusting the vacuum level to be within the range above, the dewatering efficiency may be increased while preventing damage to the raw laver leaves and avoiding sheet deformation caused by excessive dewatering.

The dewatering step may be performed until the surface of the raw laver sheet is completely dewatered. Specifically, the moisture content of the raw laver dewatered through the dewatering step (S80) may range from 75% to 85%. When adjusted to this moisture content, the adhesion between raw laver sheets may be enhanced, allowing them to maintain their sheet form on the mesh belt and be detached.

Specifically, the dewatering step (S80) may further comprise an air injection step following vacuum dewatering and allow the vacuum-dewatered raw laver to pass through the injected air and be continuously detached from the mesh belt.

The pre-drying step (S90) refers to a primary drying process conducted to suppress the shrinkage of the raw laver sheet dewatered in the dewatering step (S80). The pre-drying may be performed by fixing both sides of the raw laver sheet with conveyor belts. Further, the pre-drying may be performed by an air-drying method in which the raw laver sheet passes between injected air of both sides. The method for producing rolled dried laver of the present disclosure may include a pre-drying step before the main secondary drying step (drum-drying step (S100)), thereby further strengthening the structure of the raw laver sheet. Additionally, it may suppress laver shrinkage during the subsequent drum-drying step, which helps prevent deformation and breakage of the laver.

Specifically, the fixing both sides of the raw laver sheet may be achieved by physically fixing the raw laver sheet with a dual-belt conveyor. The material of the conveyor is not particularly limited as long as the material is heat-resistant and allows the raw laver sheet to be easily detached. In particular, by physically fixing the sheet with the conveyor and performing pre-drying using the air injection method, the shrinkage of the laver in the drying process can be effectively suppressed in the subsequent drum-drying step.

Specifically, the pre-drying step (S90) may be performed at a temperature of 30 °C to 60 °C, and more specifically 30 °C to 50 °C, 45 °C to 55 °C, 35 °C to 55 °C, 30 °C to 40 °C, or 40 °C to 60 °C.

Specifically, the pre-drying step (S90) may be performed at a humidity of 30% to 80%, and more specifically 40% to 70%, 50% to 80%, 45% to 65%, 30% to 50%, 50% to 90%, or 50% to 70%.

Specifically, the raw laver used in the pre-drying step may have a salinity of 1% to 3%, and more specifically 1% to 2.5%, 1.5% to 2.7%, or 2% to 3%.

As mentioned above, in the method for producing rolled dried laver of the present disclosure, it was confirmed that the percentage of shrinkage of the final rolled dried laver sheet can be significantly reduced by the pre-drying step in which the sheet is physically fixed by the conveyor and the temperature, humidity, and salinity are optimized. Therefore, by adjusting the temperature, humidity, and salinity of the pre-drying step to the above-described ranges, the percentage of shrinkage of the roll laver sheet to be formed can be reduced, and the uniformity can be improved.

Specifically, the pre-drying step (S90) may be performed for 10 minutes to 3 hours, more specifically 20 to 40 minutes, 25 to 35 minutes, 30 minutes to 1 hour, 1 hour to 1 hour 30 minutes, or 40 minutes to 1 hour 20 minutes.

In particular, the moisture of the raw laver sheet primarily dried through the pre-drying step (S90) may range from 30% to 80%, and more preferably from 50% to 70%.

The drum-drying step (S100) refers to a secondary drying process of the raw laver sheet primarily dried through the pre-drying step (S90) in a drum dryer.

In the method for producing rolled dried laver of the present disclosure, dried laver in a roll form can be prepared, unlike the conventional hot-air drying method, by applying drum-drying using a drum dryer as the secondary drying method. Moreover, the drying is performed by attaching the raw laver to the dryer using an applicator, thereby significantly increasing the drying efficiency. In particular, when drum-drying is applied, the laver has more uniform thickness and density compared to conventional dried laver, and the structure between raw laver particles becomes more compact, thereby enabling the production of dried laver with significantly increased strength. Additionally, by applying drum-drying, a similar effect to the hot air drying process can be achieved without performing an conventional roasting process, thereby reducing the percentage of shrinkage of the laver and shortening the overall drying time.

The drum dryer refers to a drying apparatus typically used to solidify materials by spreading liquid materials onto the surface of a rotating heated drum, where a thin film of the materials is formed and subsequently dried. Specifically, the drum-drying step (S100) may utilize a single-type drum dryer. The production method of the present disclosure can increase the drying efficiency by using a single-type drum dryer, where the applicator present on the drum surface presses the laver onto the drum surface during drying. Additionally, by adjusting the height of the applicator, thicker laver can also be freely produced. The drum dryer enhances drying efficiency by drying the raw laver sheet through a process in which the applicator positioned on the drum surface presses the sheet onto the drum surface.

Specifically, the drying linear speed of the drum dryer may range from 0.1 m/min to 5 m/min, and more specifically from 0.5 m/min to 2 m/min. By adjusting the drying line speed to the range above, it is possible to prevent the laver from burning while also facilitating detachment from the drum dryer and forming a durable sheet without tearing.

Specifically, the drying temperature of the drum dryer may range from 90 °C to 120 °C, and more specifically from 100 °C to 110 °C. By adjusting the drying temperature to the range above, it is possible to prevent the laver from burning while also facilitating detachment from the drum dryer and forming a durable sheet without tearing.

In particular, the final moisture content of the rolled dried laver that has undergone secondary drying through the drum-drying step (S100) may range from 5% to 13%, and more specifically 5% to 10%.

Through the method for producing rolled dried laver of the present disclosure, which includes the above steps, it is possible to provide rolled dried laver with improved microbial stability and uniformity. Additionally, by incorporating a combined drying process, the percentage of shrinkage may be reduced while shortening the overall drying time. In the method for producing roll laver of the present disclosure, the overall drying time comprising the time required for the pre-drying step (S90) and drum-drying step (S100) may be reduced to 1 to 2 hours, and more specifically 1 to 1.5 hours.

Another aspect of the present disclosure provides rolled dried laver produced by the method for producing rolled dried laver. In particular, the method for producing rolled dried laver is as described above.

The rolled dried laver of the present disclosure, unlike conventional standardized dried laver, is produced in a roll form and can be formed into various appearances.

Further, the rolled dried laver of the present disclosure may possess a significantly enhanced strength compared to conventional dried laver. As used herein, the term “strength” refers to the resistance to change until fracture when a load is applied to a material or component. Mainly in relation to its tear-resistance when wrapping ingredients such as rice, strength is a highly important characteristic of dried laver. Specifically, the strength of the rolled dried laver of the present disclosure may be 10 (N) or more. Since conventional dried laver typically exhibits a strength of 8 N or less, the rolled dried laver of the present disclosure exhibits an improved strength compared thereto. For example, the strength of the rolled dried laver may be a rational number between two numerical values selected from 10 N, 11 N, 12 N, 13 N, 14 N, 15 N, 16 N, 17 N, 18 N, 19 N, 20 N, 21 N, 22 N, 23 N, 24 N, 25 N, 26 N, 27 N, 28 N, 29 N, 30 N, 31 N, 32 N, 33 N, 34 N, 35 N, 36 N, 37 N, 38 N, 39 N, 40 N, 41 N, 42 N, 43 N, 44 N, 45 N, 46 N, 47 N, 48 N, 49 N, 50 N, 51 N, 52 N, 53 N, 54 N, 55 N, 56 N, 57 N, 58 N, 59 N, 60 N, 61 N, 62 N, 63 N, 64 N, 65 N, 66 N, 67 N, 68 N, 69 N, 70 N, 71 N, 72 N, 73 N, 74 N, 75 N, 76 N, 77 N, 78 N, 79 N, 80 N, 81 N, 82 N, 83 N, 84 N, 85 N, 86 N, 87 N, 89 N, 90 N, 91 N, 92 N, 93 N, 94 N, 95 N, 96 N, 97 N, 98 N, and 99 N, where the larger numerical value of the two integers is set as the upper limit and the smaller numerical value of the two integers is set as the lower limit.

Additionally, the rolled dried laver of the present disclosure is characterized by a wider range of manufacturable sheet thicknesses. For example, the thickness of the rolled dried laver of the present disclosure may be adjusted within the range from 0.10 mm to 0.5 mm, but is not limited thereto. For example, the rolled dried laver of the present disclosure may be manufactured to have significantly improved strength compared to conventional dried laver while maintaining a thinner thickness as described above. Alternatively, by adjusting the sheeting step, it can be produced with a uniform density and thickness while achieving a greater overall thickness.

More specifically, the rolled dried laver of the present disclosure can be adjusted to have various thicknesses and can be manufactured to have a thickness of 0.1 mm to 0.5 mm, which corresponds to the thickness of conventional dried laver.

The rolled dried laver of the present disclosure may have an improved percentage of shrinkage compared to conventional dried laver. As used herein, the term “percentage of shrinkage” refers to the ratio of shrinkage or reduction in area. When the original area is I₀ and the area after shrinkage is I, the percentage of shrinkage (%) can be expressed by the following equation.

Percentage of shrinkage (%)=(I₀−I)χI₀×100

The rolled dried laver of the present disclosure may have an improved percentage of shrinkage of −6% or more and less than 10%, more specifically −3% or more and less than 5%, even more specifically −1% or more and less than 3%, and even more specifically less than 1%.

The physical properties and characteristics of the rolled dried laver produced by the method for producing rolled dried laver of the present disclosure are summarized in Table 1 below.

TABLE 1

| | | Thickness | | Weight | | Strength | | Percentage |
|---|---|---|---|---|---|---|---|---|
| Category | Appearance | (per sheet) | | (per sheet) | | (N) | Moisture | of shrinkage |
| Conventional | 200 × 210 mm | 0.3 | mm | 2.5~3 | g | 7.45 | Dried laver 12% | — |
| dried laver | Rectangular | | | | | | Laver for gimbap 5% | |
| Roll dried laver of | Sheet/ | 0.10~0.5 | mm | 2.7~3.0 | g | 10 or more | 5.0~13% | less than 10% |
| present disclosure | roll form | | | | | | | |

That is, as shown in Table 1, the rolled dried laver of the present disclosure can provide high-strength rolled dried laver with various thicknesses and appearances within a narrow range. Based on these characteristics, the rolled dried laver of the present disclosure may also be applied as laver snacks with various appearances, thicknesses, and textures.

Depending on the desired product form, the rolled dried laver of the present disclosure can be cut into various shapes, lengths, and sizes to be manufactured into different forms, including dried laver, sushi laver, kimbap laver, seasoned laver, laver snacks that can be bonded with grain sheets, and mixed laver containing food powder other than laver, but is not limited thereto.

### MODE FOR CARRYING OUT THE INVENTION

The present disclosure will be described in detail by way of Examples. The Examples are provided to specifically explain the present disclosure, and the scope of the present disclosure is not limited by the Examples.

### Example 1: Evaluation of Physical Properties Based on Salinity, Humidity, and Temperature of Pre-Drying Step

First, the physical properties of the raw laver sheet were evaluated based on three factors in the pre-drying step: temperature, humidity, and salinity. The physical properties of the formed sheet were measured at a salinity of 2% to 3%, a temperature of 30 °C to 60 °C, and a humidity of 30% to 80%.

Specifically, frozen raw laver collected in Seocheon-gun (South Korea) was purchased online and used to prepare frozen raw laver. Next, the raw laver was thawed in water at room temperature for about 2 hours. The thawed raw laver was ground to a size of about 5 mm or smaller in a blender using the mixer mode and then chopped. A saline solution was prepared by weighing the amount of salt required to achieve a salinity of 2% to 3% and dissolving the salt in water. Next, 20 g of thawed raw laver was added to the saline solution and stirred for 2 hours using a magnetic stirrer. The ground raw laver was poured into a forming frame and evenly spread on a laver mat to form a laver sheet with uniform distribution.

In the pre-drying step of the formed laver sheet, experiments were conducted using Minitab Response Surface Design (Central Composite Design) to examine the optimal conditions for changes in percentage of shrinkage caused by the three factors (salinity, temperature, and humidity). Experimental planning based on the central composite design method resulted in setting a total of 30 experiments by repeating 15 experiments twice. For the repeatability of the experiment, each experiment was conducted by producing two sheets of dried laver, ensuring two-time repeatability. The experimental results are shown in Table 2 below.

TABLE 2

| | Temperature | Humidity | Salinity | Width | Length | Area | Area | | Weight |
|---|---|---|---|---|---|---|---|---|---|
| No. | (°C) | (%) | (%) | (mm) | (mm) | (mm\hat{ }2) | ratio | Moisture | (g) |
| 1 | 19.8 | 55.0 | 2.5 | 194 | 182 | 35,308 | 90.6% | 14.70% | — |
| 2 | 19.8 | 55.0 | 2.5 | 196 | 174 | 34,104 | 87.6% | 13.60% | — |
| 3 | 30.0 | 30.0 | 2.0 | 182 | 174 | 31,668 | 81.3% | 16.78% | 2.50 |
| 4 | 30.0 | 30.0 | 2.0 | 180 | 152 | 27,360 | 70.2% | 16.26% | 2.35 |
| 5 | 30.0 | 30.0 | 3.0 | 190 | 184 | 34,960 | 89.8% | 15.94% | 2.17 |
| 6 | 30.0 | 30.0 | 3.0 | 184 | 182 | 33,488 | 86.0% | 15.39% | 2.43 |
| 7 | 30.0 | 80.0 | 2.0 | 190 | 185 | 35,150 | 90.2% | 13.08% | 2.64 |
| 8 | 30.0 | 80.0 | 2.0 | 190 | 170 | 32,300 | 82.9% | 16.69% | 3.40 |
| 9 | 30.0 | 80.0 | 3.0 | 190 | 185 | 35,150 | 90.2% | 15.74% | 2.08 |
| 10 | 30.0 | 80.0 | 3.0 | 190 | 170 | 32,300 | 82.9% | 15.90% | 2.49 |
| 11 | 45.0 | 20.0 | 2.5 | 170 | 158 | 26,860 | 69.0% | 16.42% | 2.52 |
| 12 | 45.0 | 20.0 | 2.5 | 190 | 172 | 32,680 | 83.9% | 11.67% | 2.09 |
| 13 | 45.0 | 55.0 | 1.7 | 198 | 190 | 37,620 | 96.6% | 13.87% | 2.35 |
| 14 | 45.0 | 55.0 | 1.7 | 200 | 190 | 38,000 | 97.6% | 14.93% | 1.52 |
| 15 | 45.0 | 55.0 | 2.5 | 200 | 196 | 39,200 | 100.6% | 15.23% | 1.96 |
| 16 | 45.0 | 55.0 | 2.5 | 204 | 192 | 39,168 | 100.6% | 15.73% | 1.75 |
| 17 | 45.0 | 55.0 | 3.3 | 198 | 190 | 37,620 | 96.6% | 16.79% | 2.20 |
| 18 | 45.0 | 55.0 | 3.3 | 200 | 190 | 38,000 | 97.6% | 15.70% | 1.73 |
| 19 | 45.0 | 97.0 | 2.5 | 210 | 196 | 41,160 | 105.7% | 13.94% | 1.56 |
| 20 | 45.0 | 97.0 | 2.5 | 210 | 196 | 41,160 | 105.7% | 11.27% | 1.95 |
| 21 | 60.0 | 30.0 | 2.0 | 184 | 177 | 32,568 | 83.6% | 15.79% | 2.55 |
| 22 | 60.0 | 30.0 | 2.0 | 183 | 180 | 32,940 | 84.6% | 14.24% | 2.24 |
| 23 | 60.0 | 30.0 | 3.0 | 182 | 176 | 32,032 | 82.2% | 16.72% | 2.39 |
| 24 | 60.0 | 30.0 | 3.0 | 183 | 179 | 32,757 | 84.1% | 16.83% | 1.99 |
| 25 | 60.0 | 80.0 | 2.0 | 195 | 185 | 36,075 | 92.6% | 15.58% | 1.99 |
| 26 | 60.0 | 80.0 | 2.0 | 195 | 185 | 36,075 | 92.6% | 15.52% | 2.05 |
| 27 | 60.0 | 80.0 | 3.0 | 220 | 185 | 40,700 | 104.5% | 15.41% | 1.82 |
| 28 | 60.0 | 80.0 | 3.0 | 190 | 187 | 35,530 | 91.2% | 15.23% | 2.04 |
| 29 | 70.2 | 55.0 | 2.5 | 204 | 198 | 40,392 | 103.7% | 15.01% | 2.11 |
| 30 | 70.2 | 55.0 | 2.5 | 204 | 198 | 40,392 | 103.7% | 14.09% | 1.56 |

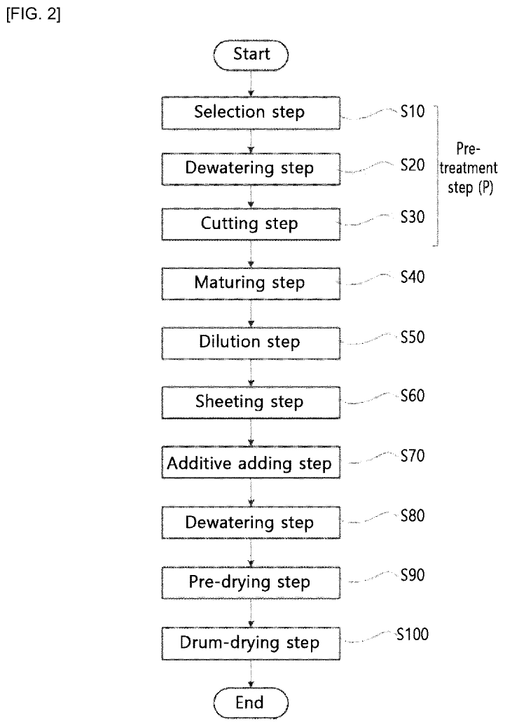

Based on the results above, a contour plot of the area ratio to humidity and temperature is shown in FIG. 3.

As shown in Table 2 and FIG. 3, it was confirmed that the laver sheet formed under the pre-drying conditions of a temperature at 40 °C to 60 °C, humidity at 50% to 90%, and salinity at 2% to 3% has the reduced shrinkage and the highest area ratio. Based on such results, it was confirmed that high-quality roll laver with uniformity and minimal shrinkage can be produced by adjusting the salinity, temperature, and humidity of the pre-drying step.

### Example 2: Preparation of Rolled Dried Laver

Ten kilograms of raw laver (centrifuge-dehydrated, moisture 86%), purchased from a dried laver manufacturing company (Yangji Cooperative Association), were cut into pieces approximately 3 mm to 5 mm in size using a blender and dispersed into 80 L of water. 1.6 kg of salt was added to achieve a salinity of 2%, and the solution was matured for 2 hours while stirring with a agitator

Next, using a pump, the solution was transferred to a sheet-forming feeding tank, and 80 liters of water with 0% salinity was added to adjust the concentration of the raw laver to 6.25%. Using a mono pump, the raw laver dispersed in the saline solution was transferred to the distributer and subsequently to the headbox of the custom-made sheet forming machine.

The raw laver, adhered to a mesh belt (200 mesh) inclined at 20 degrees with a vacuum of 125 mbar applied to a lower part thereof, formed a sheet and was discharged from the headbox. In particular, the linear speed of the mesh belt was 0.6 m/min. The raw laver sheet discharged from the headbox, with some surface moisture, was sprinkled with 30 g of seasoning using a vibration feeder and transported. In particular, the seasoning was dissolved by the moisture on the surface.

The raw laver sheet, with seasoning sprinkled on its surface, was completely surface-dehydrated as it passed through a three-stage vacuum (150 mbar) box, thereby allowing the dissolved seasoning on the surface to penetrate into the interior of the raw laver sheet. In particular, the moisture content of the raw laver sheet was 80%. The surface-dehydrated raw laver sheet was detached from the conveyor belt by air flowing from the slot-shaped air box underneath and transferred to the pre-drying input conveyor belt.

The raw laver sheet transferred to the pre-drying input conveyor belt was fed into the custom-made pre-dryer by overlapping the pre-drying input conveyor belt with the upper conveyor belt. The double-layered conveyor belt, with the original material sandwiched in the middle, moves continuously on top of the rollers to maintain the proper tension and physically fix the raw laver, preventing shrinkage during drying and thereby suppressing shrinkage. The conveyor belt was passed through air at 60 °C and 60% humidity to dry the raw laver sheet to 60% moisture. The dried raw laver sheet was detached by air flowing from the slot-shaped air box underneath and transferred to the transfer conveyor belt to the drum dryer. The linear speed was maintained at 0.6 m/min, which is the same as the linear speed of the sheet forming machine.

The raw laver sheet from the pre-drying process was fed into the drum dryer loading section by the transfer conveyor belt. It was then pressed by one or two applicator rollers to ensure surface uniformity and attached to the drum surface for drying. In particular, the linear speed of the drum dryer was 0.6 m/min, with the temperature maintained at 100 °C to 110 °C under the steam pressure of 4 kg/cm².

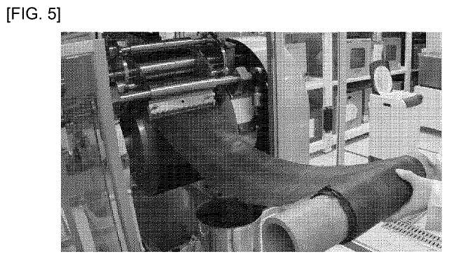

The raw laver sheet, dried to the target moisture level, was removed from the surface by a cutting blade located at the rear end of the drum dryer, and then wound by a winder to obtain a roll of laver, mixed with the final seasoning, to thereby obtain laver with a length of 95.3 m and a weight of 1.43 kg (FIG. 5). The results of producing rolled dried laver according to the manufacturing process of Example 1 are shown in Table 3 below.

TABLE 3

| | | Thickness | Weight | Strength | |
|---|---|---|---|---|---|
| Category | Appearance | (per sheet) | (per sheet) | (N) | Moisture |
| Conventional | 200 × 210 mm, | 0.3 mm | 2.5~3 g | 7.45 | Dried laver 12% |
| dried laver | 250~300 g/bundle | | | | Laver for gimbap 5% |
| | (100 sheets) | | | | |
| Roll dried laver of | 95.3 m, 1.43 kg | 0.16 mm | 2.7 g | 52.1 | 7.2% |
| present disclosure | Roll form | | | | |

As shown in Table 3, it was found that the method for producing rolled dried laver of the present disclosure significantly can improve the strength of laver by more than seven times compared to conventional dried laver, while being capable of maintaining an exceptionally thin thickness. From the above results, it was confirmed that the rolled dried laver of the present disclosure has solved the issue of tearing in the process of producing kimbap, and thus, it can be effectively utilized.

Moreover, as shown in FIG. 5, the method for producing rolled dried laver of the present disclosure produces dried laver in a roll form, allowing for the production of laver with various appearances through cutting, as well as laver snacks and other products.

As set forth above, a person skilled in the art will be able to understand that the present disclosure may be embodied in other specific forms without departing from the technical spirit or essential characteristics thereof. Therefore, the embodiments described above should be construed as being exemplified and not limiting the present disclosure. It should be understood that all changes or modifications derived from the definitions and the scopes of the claims and their equivalents fall within the scope of the present disclosure.

1. A method for producing rolled dried laver, comprising:
a sheeting step of forming a raw laver sheet by loading raw laver onto a mesh belt;
a dewatering step of dewatering the raw laver sheet formed in the sheeting step to produce a dewatered raw laver sheet;
a pre-drying step of primarily drying the dewatered raw laver sheet from the dewatering step to produce a primarily dried raw laver sheet; and
a drum-drying step of secondarily drying the primarily dried raw laver sheet using a drum dryer after the pre-drying step.

2. The method for producing rolled dried laver of claim 1, wherein the sheeting step to drum-drying step are performed continuously.

3. The method for producing rolled dried laver of claim 1, further comprising a pre-treatment step of removing foreign substances contained in the harvested raw laver before the sheeting step.

4. The method for producing rolled dried laver of claim 3, wherein the pre-treatment step comprises one or more of the following steps: a sorting step of removing foreign substances in the harvested raw laver, a dewatering step of decreasing the water content in the raw laver, and a cutting step of cutting the raw laver into small pieces.

5. The method for producing rolled dried laver of claim 1, further comprising a maturing step of maturing the raw laver before the sheeting step.

6. The method for producing rolled dried laver of claim 5, further comprising a dilution step of mixing the matured raw laver from the maturing step with water.

7. The method for producing rolled dried laver of claim 1, wherein the sheeting step forms a raw laver sheet by vacuum dewatering the loaded raw laver on the mesh belt.

8. The method for producing rolled dried laver of claim 7, wherein the vacuum is 100 mbar to 150 mbar.

9. The method for producing rolled dried laver of claim 1, further comprising an additive adding step adding raw material powder or food additives to the formed raw laver sheet from the sheeting step to improve taste and flavor.

10. The method for producing rolled dried laver of claim 1, wherein the sheeting step allows adjustment of the thickness of the raw laver sheet to be formed by controlling three factors: the concentration of the raw laver, the feeding speed, and the movement speed of the mesh belt.

11. The method for producing rolled dried laver of claim 1, wherein the dewatering step is performed by vacuum dewatering.

12. The method for producing rolled dried laver of claim 11, wherein the vacuum dewatering is performed at 120 mbar to 170 mbar.

13. The method for producing rolled dried laver of claim 1, wherein the pre-drying step is performed by fixing both sides of the raw laver sheet with a conveyor.

14. The method for producing rolled dried laver of claim 1, wherein the pre-drying step is performed by air-drying.

15. The method for producing rolled dried laver of claim 1, wherein the pre-drying step is performed at 30 °C to 60 °C.

16. The method for producing rolled dried laver of claim 1, wherein the pre-drying step is performed at a humidity of 40% to 60%.

17. The method for producing rolled dried laver of claim 1, wherein the drum dryer is a single-type drum dryer.

18. The method for producing rolled dried laver of claim 1, wherein the drying linear speed of the drum dryer is 0.5 m/min to 2 m/min.

19. The method for producing rolled dried laver of claim 1, wherein the drying temperature of the drum dryer is 100 °C to 110 °C.

20. Rolled dried laver prepared by the method for producing rolled dried laver according to claim 1.

21. The rolled dried laver of claim 20, wherein the strength of the rolled dried laver is 10 N or more and less than 100 N.

22. The rolled dried laver of claim 20, wherein the percentage of shrinkage of the rolled dried laver is −1% or more and less than 5%.
